(19) United States
(12) Patent Application Publication
(10) Pub. No.: US 2002/0196267 A1
(43) Pub. Date: Dec. 26, 2002

(54) Image display device

(76) Inventors: Toshio Obayashi, Fukaya-shi (JP); Tsutomu Sakamoto, Fukaya-shi (JP)

Correspondence Address: PILLSBURY WINTHROP, LLP, P.O. BOX 10500, MCLEAN, VA, 22102, US

(21) Appl. No.: 10/175,152

(22) Filed: Jun. 20, 2002

(30) Foreign Application Priority Data
Jun. 21, 2001 (JP) 2001-188379

(51) Int. Cl. G09G 3/36

(52) U.S. Cl. 345/690

(57) ABSTRACT

An image display device includes a display section in which (m×n) display pixels are arrayed in a matrix form and located at intersections of m row wirings and n column wirings, a length L of the row being greater or equal to a length K of the column. Particularly, the display device further includes a scanning driver which sequentially selects the column wirings, and a driving circuit which supplies a drive signal to each of the row wirings based on a video signal synchronously with selection made by the scanning driver.

### CROSS-REFERENCE TO RELATED APPLICATIONS

This application is based upon and claims the benefit of priority from the prior Japanese Patent Application No. 2001-188379 filed Jun. 21, 2001, the entire contents of which are incorporated herein by reference.

### BACKGROUND OF THE INVENTION

1. Field of the Invention

The present invention relates to an image display device of driving a matrix array of display pixels, and more particularly to the image display device called a field emission display (FED), for example.

2. Description of the Related Art

An FED is known as an image display device of a structure in which row wirings (row lines) and column wirings (column lines) are arranged to intersect from each other, with surface conduction type electron emission elements (display pixels) disposed at intersections thereof. Generally, the FED comprises a scanning section for sequentially scanning and selecting the row lines in units of lines and a driving section for supplying drive signals corresponding to a video signal to the column lines in units of lines (for example, Jpn. Pat. Appln. KOKAI Publication No. 9-297556).

In an image display device using surface conduction type electron emission elements, each display pixel is formed by combining three surface conduction type electron emission elements and red (R), green (G) and blue (B) phosphors which illuminate upon irradiation of electron beams from the three electron emission elements.

An image is displayed by the pixels driven in a manner that the row lines (H1 to Hq) are sequentially scanned and selected by the scanning driver, while pulse width modulation signals (drive signals) are supplied from the drive circuit to the column lines (G1 to Gp).

Generally, the screen of the image display device has an aspect ratio that the horizontal length is larger than the vertical length (4:3 or 16:9). Thus, the number of display pixels connected to each row line is greater than that of display pixels connected to each column line.

The image display device as disclosed in Jpn. Pat. Appln. KOKAI Publication No. 9-297556 includes a simple matrix wired array of surface conduction type electron emission elements. In the matrix wired array, different potentials are applied to the elements due to the voltage drop across the wiring resistance. That is, the potential actually applied to each element is lowered in proportion to a wiring length between the drive voltage supply terminal and the element, so that an uneven distribution occurs in the potentials of the elements.

Particularly, a horizontally elongated display device whose screen has an aspect ratio of 16:9 (horizontal length to vertical length) has entered the main stream. With this screen, an increased number of display pixels are arranged along the row line (scanning line), making it more likely to suffer from the above problem.

For example, where display pixels are arrayed in a ratio of 1280:720 (=columns:rows), it comes that 1280×3 (RGB) surface conduction type electron emission elements are provided for each row line (scanning line). Due to this, the influence of the wiring resistance becomes more serious and correspondingly, uneven distribution occurs in the luminous intensity of the elements arranged in the row direction, thereby deteriorating the quality of the image display device considerably. For example, a difference of at least 2 to 3V in potential occurs between both ends of the row line.

### BRIEF SUMMARY OF THE INVENTION

Accordingly, an object of the present invention is to provide an image display device that can display a high-quality image, while suppressing unevenness in brightness caused due to the voltage drop across the wiring resistance.

To achieve the above object, the present invention provides an image display device comprising a display section in which (m×n) display pixels are arrayed in a matrix form and located at intersections of m row wirings and n column wirings, a length L of the row being greater or equal to a length K of the column; a scanning section which sequentially selects the column wirings; and a driving section which supplies a drive signal to each of the row wirings based on a video signal synchronously with selection made by the scanning section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a schematic view showing a first embodiment of the present invention;

FIG. 2 is a schematic view showing a second embodiment of the present invention;

FIG. 3 is a timing chart showing drive timings of the column lines shown in FIG. 2;

FIG. 4 is a diagram showing a concrete example of a scanning direction changer in an image processing circuit;

FIGS. 5A and 5B are explanatory diagrams of the structure of a display pixel using a surface conduction type electron emission element;

FIG. 6 is a diagram showing an example of a driving circuit in the display device of the embodiment; and

FIG. 7 is a schematic view showing a third embodiment of the present invention.

### DETAILED DESCRIPTION OF THE INVENTION

Hereinafter, preferred embodiments of the present invention will be described with reference to the accompanying drawings.

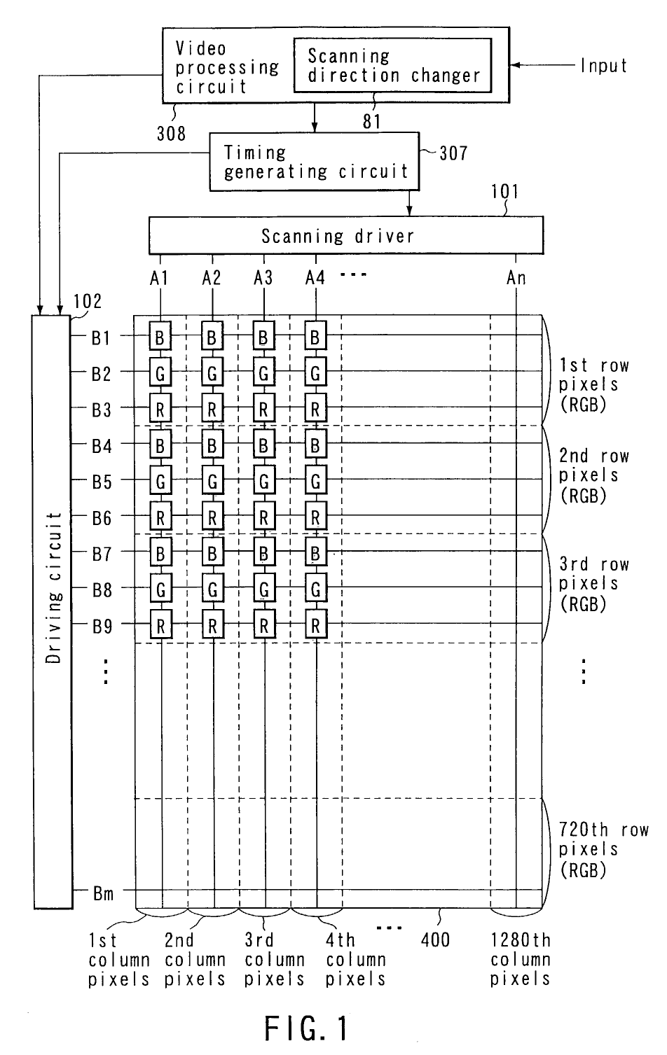

FIG. 1 shows a first embodiment of the present invention. It is assumed that this image display device has for example, pixels of 1280:720 (horizontal:vertical). For color display, the number of display pixels is 1280:720 (horizontal:vertical)×3 (corresponding to R, G and B). Thus, 720×3 (corresponding to R, G and B) display pixels are connected to a row line (scanning line).

The row line is driven by a scanning driver 101. The scanning driver 101 sequentially scans the row lines (A1 to An) in units of lines. On the other hand, the column line is connected to a driving circuit 102. The driving circuit 102 supplies those drive signals to the column lines (B1 to Bm), which are pulse-width modulated in units of column lines. The pulse width is modulated depending upon brightness such that the maximum value falls within the drive period of a single column line. Therefore, the pulse width becomes small for a pixel of a low brightness, and large for a pixel of a high brightness. In this manner, an image is displayed in a display section.

Reference numeral 308 denotes a video processing circuit. This video processing circuit 308 incorporates a scanning direction changer 81 which temporarily stores a video signal input as pixel data for one field or one frame into a buffer memory in units of rows and retrieves the pixel data in units of columns so that the scanning direction is changed.

Synchronously with pixel data retrieval from the buffer memory in the video processing circuit 81, a timing generating circuit 307 sets up ON-timing of each column line for the scanning driver 101 and sample and output timings of the retrieved data for the driving circuit 102.

In the display section 400, the pixel colors of R, G, B, R, G, B, R, G, B, . . . are assigned to the pixels arranged along each vertical (column) line instead of each horizontal (row) line.

In the above-mentioned display device, the scanning driver 101 sequentially selects and drives the column lines A1, A2, A3, . . . during the period of one field or one frame. Similarly, the drive circuit 102 outputs the video signal of rows to the row lines B1, B2, B3, . . . during the period of one field or one frame. Consequently, an image is displayed in the display section 400.

According to the device of the first embodiment, the number of the display pixels assigned to a wiring to be scanned is 720×3 which is smaller than the conventional example of 1280×3, so that the value of wiring resistance is reduced by this decreased amount, thereby unevenness in brightness is eliminated.

As compared to the conventional example, the number of lines to be scanned by the scanning driver 101 during the period of one field or one frame is increased from 720 to 1280. This is an increase of 78%, which is sufficiently within an operating capacity range.

The aspect ratio of the horizontal length to the vertical length is 9:16 and the length of the column line to be driven by the scanning driver 101 is about 56% the length of the row line to be conventionally driven by the Y driver. This means that the wiring resistance of the column line is about 56% of the conventional wiring. As a result, the difference in brightness for each column line is reduced from the conventional level.

The present invention is not restricted to the above-described embodiment.

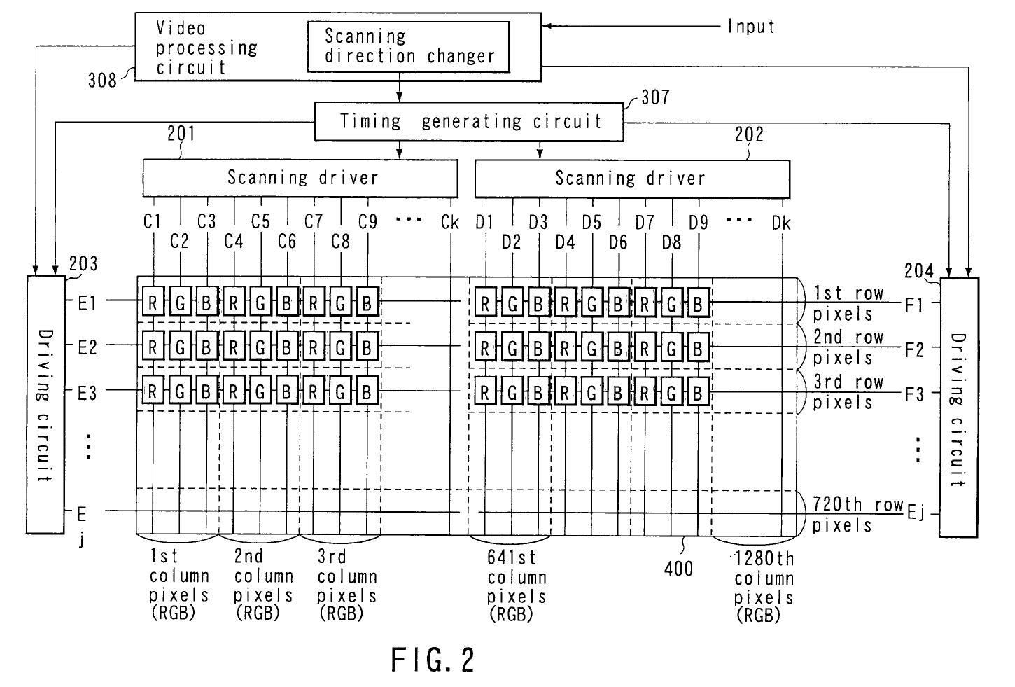

FIG. 2 shows a second embodiment of the present invention. Here, in a display section 400, display pixels are arrayed horizontally and vertically as a matrix of 1280×3 (RGB):720. The display pixels connected to the column lines (C1 to Ck) are connected to the row lines (E1 to Ej), while the display pixels connected to the column lines (D1 to Dk) are connected to the row lines (F1 to Fj). That is, according to this embodiment, the column lines of the display section 400 are divided to two blocks formed in the left and right regions. Then, the column lines (C1 to Ck) and row lines (E1 to Ej) are used to drive the display pixels in the left region, while the column lines (D1 to Dk) and row lines (F1 to Fj) are used to drive the display pixels in the right region.

Therefore, the scanning driver 201 and the driving circuit 203 are assigned to the column and row lines in the right region while the scanning driver 202 and the driving circuit 204 are assigned to the column and row lines in the left region.

The timing generating circuit 307 provides timing signals to the driving circuits 203, 204 and the scanning drivers 201, 202. The video signal for the left region is supplied from the video processing circuit to the driving circuit 203, and the video signal for the right region is supplied from the video processing circuit 308 to the driving circuit 204.

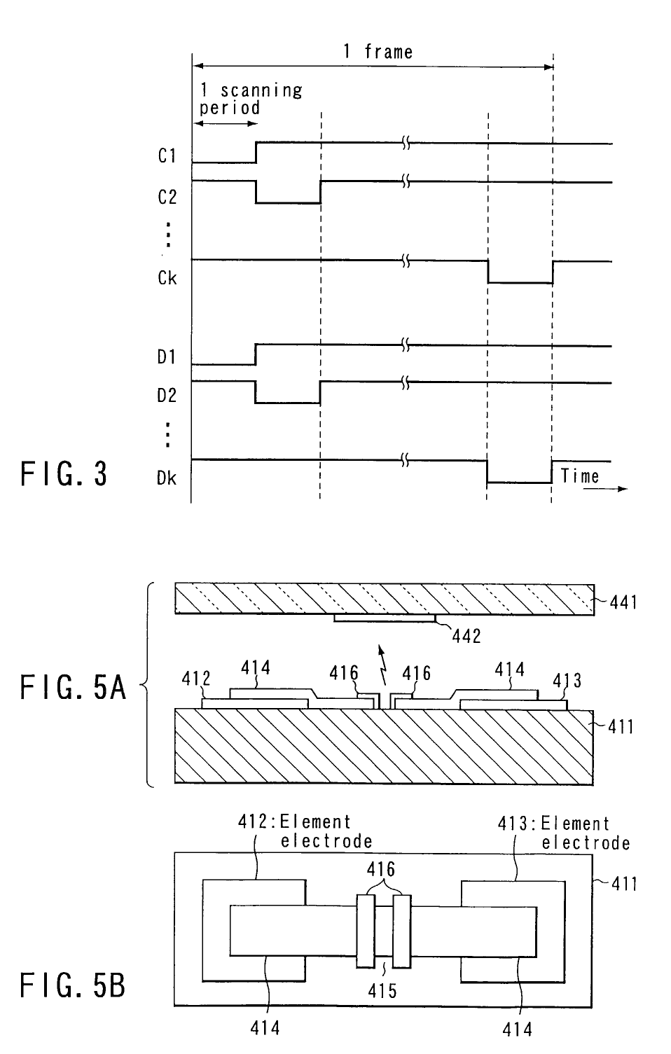

FIG. 3 shows the drive timings of the scanning lines (column lines) for explaining the operation of the display device shown in FIG. 2. The column lines in the left region are scanned one by one in the order of C1, C2, C3, . . . Ck, and synchronously with this, the column lines in the right region are scanned one by one in the order of D1, D2, D3, . . . Dk.

In the above-described embodiment, each scanning driver 201, 202 only has to scan 1280×3/(2×3) lines during the period of one frame. These lines may be divided additionally.

According to this embodiment, the number of the display pixels assigned to a wiring to be scanned is decreased to 720 to reduce the value of wiring resistance. Thus, unevenness in brightness is eliminated. Further, since two scanning lines are concurrently driven, the operation frequency of the scanning driver can be lowered.

Although according to this embodiment, the column lines to be scanned are divided to two blocks formed in the left and right regions, two blocks of column lines may be arranged alternately in an order of C1, D1, C2, D2, . . . Ck, Dk, for example.

Particularly, in an electron emission element, as a current of several mA flows to emit electrons, when the number of the display pixels is increased, the electron emission element is more easily affected by the wiring resistance. Thus, the display device of this embodiment is configured to reduce the influence of the wiring resistance.

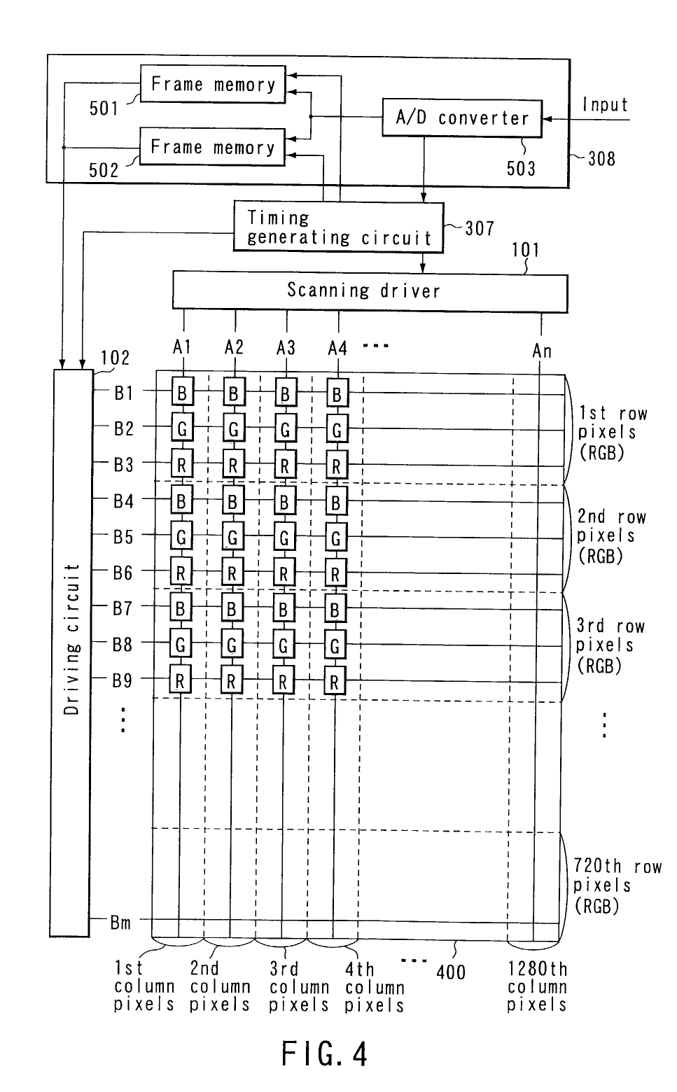

FIG. 4 shows a concrete example of the scanning direction changer. Usually, an NTSC type video signal is produced to sequentially drive display pixels arranged in the row (lateral or horizontal) direction. After the video signal is converted to digital pixel data through an A/D converter 503, pixel data for one frame are written into a frame memory 501 in units of rows and when all the pixel data for one frame have been stored, the pixel data are read out from the frame memory 501 in units of columns to sequentially drive the display pixels arranged in the column (longitudinal or vertical) direction. While the pixel data for one frame are read out from the frame memory 501, the pixel data for the next frame data are written into another frame memory 502 in units of rows. The pixel data for the next frame are read out from the frame memory 501 in units of columns, while writing to the frame memory 501 is performed in the same manner as described above. After the pixel data are written into a selected one of the frame memories 501, 502 in the order corresponding to the display pixels arranged in the row direction, these pixel data are read out from the selected frame memory in the order corresponding to the display pixels arranged in the column direction. As a result, the scanning direction is changed.

Although in the drawings of the above-described embodiments, display pixels are arrayed in a striped form, the present invention is applicable to the case where the display pixels are arrayed in a delta form. Further, the present invention is not restricted to a type in which the scanning driver is disposed on one side of the wirings and connected thereto, it is also applicable to the type in which the scanning driver is disposed on both sides of the wirings and connected thereto.

Next, the structure of the display pixel in the display section 400 will be described.

Referring to FIGS. 5A and 5B, reference numeral 411 denotes a substrate, reference numerals 412 and 413 denote element electrodes, reference numeral 414 denotes a conductive thin film, reference numeral 415 denotes an electron emission member formed by an electro forming process, and reference numeral 416 denotes a thin film formed by an electro activation process.

As the substrate 411, for example, various kinds of glass substrates such as quartz glass and blue glass, various kinds of ceramic substrate such as alumina or a substrate produced by overlaying an insulating layer such as SiO₂ on the above described various kinds of substrates are available.

The element electrodes 412 and 413 are provided on the substrate 411 in parallel to the substrate surface and formed of conductive material properly selected from metals such as Ni, Cr, AuTiMo, W, Pt, Ti, Cu, Pd and Ag, alloy of these metals, metallic oxide such as In₂O₃-SnO₂, semiconductor such as polysilicon, and the like. Although the electrode can be formed easily by using a film forming technology such as vacuum deposition with patterning technology such as photolithography and etching, it is permissible to employ other methods (for example, printing).

The shape of the element electrodes 412 and 413 is designed appropriately corresponding to the application purpose of a given electron emission element. Generally, an electrode interval L is designed by selecting an appropriate value from a range of several hundred Angstrom to several hundred micrometers and particularly a range of several micrometers to several tens of micrometers is preferable for application to the imaging device. Further, as a thickness d of the element electrode, an appropriate value is selected from a range of several hundred Angstroms to several micrometers.

A particle film is used for the conductive thin film 414. This film is a film containing a great number of particles as composition element (including island-like aggregates). If the particle film is investigated microscopically, usually, a structure in which individual particles are disposed separately, disposed adjacent to each other, or, overlap each other, is observed.

The diameter of the particles used for the particle film is within a range of several Angstroms to several thousand Angstroms and more preferably, it is within a range of 10 Angstroms to 200 Angstroms. The thickness of the particle film is set up appropriately considering several conditions described below. The conditions include a condition necessary for connecting to the element electrode 412 or 413 electrically, a condition necessary for executing the electro forming favorably, a condition necessary for setting electric resistance of the particle film itself to an appropriate value and the like.

Although the particle diameter is in a range of several Angstroms to several thousand Angstroms, more preferably it is within a range of 10 Angstroms to 500 Angstroms.

The material which can be used to form the particle film includes for example, metals such as Pd, Pt, Ru, Ag, Au, Ti, In, Cu, Cr, Fe, Zn, Sn, Ta, W and Pb, oxides such as PdO, SnO₂, In₂O₃, PbO and Sb₂O₃, borides such as HfB₂, ZrB₂, LaB₆, CeB₆, YB₄ and GdB₄, carbides such as TiC, ZrC, HfC, TaC, SiC and WC, nitrides such as TiN, ZrN and HfN, semiconductor such as Si and Ge, carbon and the like and any one is selected from these materials appropriately.

Although as described above, the conductive thin film 414 is formed with a particle film, its sheet resistance value is designed to be in a range of 10³ to 10⁷ (Ohm/sq).

Because the conductive thin film 414 and the element electrodes 412, 413 are desired to be electrically connected, they are so structured as to partially overlap. As for the overlapping manner, although in FIG. 5, the substrate, element electrode and conductive thin film are overlaid in order from the bottom, it is permissible to overlay the substrate, conductive thin film and element electrode in this order from the bottom as needed.

The electron emission member 415 is a crack-shaped part formed in the conductive thin film 414 and has a higher resistance than the surrounding conductive thin film in terms of electricity. The crack-shaped part is formed by carrying out the electro forming process, which will be described later, on the conductive thin film 414. In some case, particles of several Angstroms to several hundred Angstroms in diameter are disposed within the crack-shaped part. Because the position and configuration of an actual electron emission member are difficult to represent accurately, FIGS. 5A and 5B show them schematically.

The thin film 416 is a thin film composed of carbon or carbon compound and covers the electron emission member 415 and its surroundings. The thin film 416 is formed by carrying out the electro activation process, described later, after the electro forming process.

The thin film 416 is composed of any one of monocrystal graphite, polycrystal graphite and non-crystal carbon or mixture thereof and although the film thickness is set to 500 Angstroms or less, it is more preferably 300 Angstroms or less.

In the aforementioned electron emission element (display pixel), if a voltage is applied between the element electrodes 412 and 413, electrons are emitted from the electron emission member 415. Consequently, electrons emitted from the electron emission member 415 collide with a phosphor dot 442 coated on a glass substrate 441 as shown in FIG. 5A so as to obtain illumination. A voltage is supplied to the phosphor dot 442 through a transparent electrode. The element electrodes 412 and 413 are connected to the column wiring and row wiring described before, respectively.

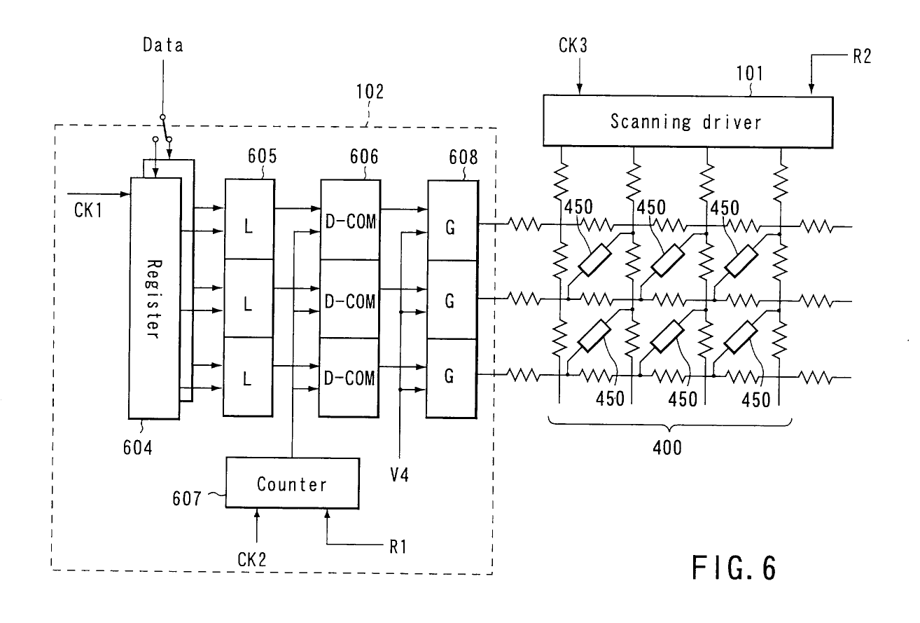

FIG. 6 shows the display section 400 schematically while the scanning driver 101 and the driving circuit 102 are represented in a simple way. In the display section 400, reference numeral 450 denotes display pixels. The driving circuit 102 has a register 604 for fetching pixel data and a latch circuit 605 for latching the pixel data in this register 601 by the unit of columns.

Each pixel data in the latch circuit 605 is inputted to a data comparator 606. Data-comparing portions in the data comparator 606 are prepared in the same number as respective pixels. Each data-comparing portion compares count data from a counter 607 with pixel data. Then, if there is less count data than pixel data, a high level is outputted and if there is more count data than pixel data, a low level is outputted.

The output of the data-comparing portion is supplied to a gate circuit 608 each having a corresponding gate portion. When a high level is given from a corresponding comparing portion, each gate portion of the gate circuit outputs a voltage of 4V and supplies it to a corresponding row wiring. When a low level is given from a corresponding comparing portion, it outputs a voltage of 0V and supplies it to a corresponding row wiring.

The data comparator 605 and the gate circuit 608 compose a pulse width modulator. The width of a pulse outputted by the pulse width modulator is variable depending upon the value of the pixel data. If the value of the pixel data is large, the pulse width increases. If the value of the pixel data is small, the pulse width decreases. Consequently, in the display pixel which is supplied with a pulse from the gate circuit 608, the brightness varies according to the pulse width, that is, gradation is presented.

The counter 607 is reset by reset pulse R1 so as to count clock CK2. The time between the first reset pulse R1 and the second one is the value T1, which is obtained by dividing the time of the vertical period by the number of display pixels on a single row wiring. However, if the scanning driver 101 selects column wirings by the unit of plural (u) column wirings, the value T1 is divided by u. The scanning driver 101 is a register which sequentially selects the column wirings and is reset with a reset pulse R2. Time between the first reset pulse R2 and the second one is equal to the time of the vertical period.

The embodiments of the present invention are not restricted to the above-described examples.

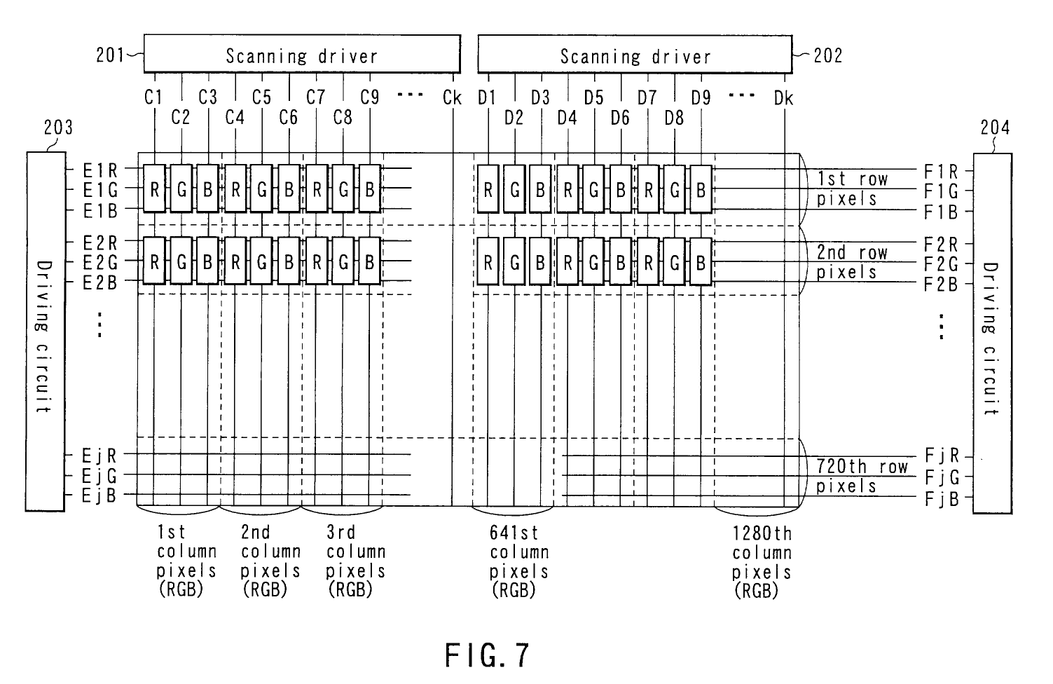

FIG. 7 shows yet another embodiment of the embodiment shown in FIG. 2. In a display section 400, display pixels are arrayed laterally and longitudinally as a matrix of 1280×3(RGB):720. Each red display pixel is connected to one of three column lines.

On the side of a scanning driver 201, for example, column lines C1, C4, C7, . . . are connected to red display pixels of each row and the red display pixels of each column are connected to row lines E1R-EjR. Column lines C2, C5, C8, . . . are connected to green display pixels of each-row and the green display pixels of each column are connected to row lines E1G-EjG. Further, column lines C3, C6, C9, . . . are connected to blue display pixels of each row and the blue display pixels of each column are connected to row lines E1B-EjB.

On the side of a scanning driver 202, column lines D1, D4, D7, . . . are connected to red display pixels of each row and the red display pixels of each column are connected to row lines F1R-FjR. Column lines D2, D5, D8, . . . are connected to green display pixels of each row and the green display pixels of each column are connected to row lines F1G-FjG. Further, column lines D3, D6, D9, . . . are connected to blue display pixels of each row and the blue display pixels of each column are connected to row lines F1B-FjB.

With this configuration, the respective scanning drivers 201 and 202 only have to scan (1280×3)/(2×3) lines during the period of one frame. ×3 means that the RGB are scanned at the same time. Therefore, the frequency is determined such that 640 pulses are output during the period of one frame. At this frequency, a more sufficient operating capacity is secured.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display device comprising:
a display section in which (m×n) display pixels are arrayed in a matrix form and located at intersections of m row wirings and n column wirings, a length L of the row being greater or equal to a length K of the column;
a scanning section which sequentially selects said column wirings; and
a driving section which supplies a drive signal to each of said row wirings based on a video signal synchronously with selection made by said scanning section.

2. An image display device according to claim 1, wherein said column wirings are connected to said display pixels for color display.

3. An image display device according to claim 1, wherein said scanning section is provided for blocks of the column wirings located in scanning regions divided from said display section and configured to sequentially select the column wirings of each block; and
said driving section is configured to supply a drive signal to each of said row wirings based on a video signal synchronously with selection made by said scanning section.

4. An image display device according to claim 3, wherein the scanning section includes:
a first scanning circuit assigned to n/2 column wirings located in one of the scanning regions; and
a second scanning circuit assigned to n/2 column wirings located in another of the scanning regions; and
said driving section includes:
a first driving circuit which sequentially supplies a drive signal based on a video signal to each of the row wirings intersecting the n/2 column wirings to which said first scanning circuit is assigned, synchronously with selection made by said first scanning circuit; and
a second driving circuit which sequentially supplies a drive signal based on a video signal to each of the row wirings intersecting the n/2 column wirings to which said second scanning circuit is assigned, synchronously with selection made by said second scanning circuit.

5. An image display device according to claim 3, wherein said first and second scanning circuits are configured to sequentially select the column wirings.

6. An image display device according to claim 1, wherein said display pixel includes an electron emission element.

7. An image display device according to claim 1, wherein the video signal is supplied from a video processing circuit to said driving section, and said video processing circuit includes a scanning direction changer which stores input pixel data into a frame memory in units of rows and retrieves the pixel data from said frame memory in units of columns.

8. An image display device according to claim 4, wherein the video signal is supplied from a video processing circuit to said first and second driving circuit, and said video processing circuit includes a scanning direction changer which stores input pixel data into a frame memory in units of rows and retrieves the pixel data for one scanning region from said frame memory in units of columns as the video signal to be supplied to said first driving circuit and the pixel data for the other scanning region in units of columns as the video signal to be supplied to said second driving circuit.

9. An image display device comprising:
a display section in which (m×n) display pixels are arrayed in a matrix form and located at intersections of m row wirings and n column wirings, a length L of the row being greater or equal to a length K of the column;
scanning means for sequentially selecting said column wirings; and
driving means for supplying a drive signal to each of said row wirings based on a video signal synchronously with selection made by said scanning means.

10. An image display device according to claim 9, wherein said column wirings are connected to said display pixels for color display.

11. An image display device according to claim 9, wherein said scanning means is provided for blocks of the column wirings located in scanning regions divided from said display section and configured to sequentially select the column wirings of each block; and
said driving means is configured to supply a drive signal to each of said row wirings based on a video signal synchronously with selection made by said scanning means.

12. An image display device according to claim 11, wherein the scanning means includes:
a first scanning circuit assigned to n/2 column wirings located in one of the scanning regions; and
a second scanning circuit assigned to n/2 column wirings located in another of the scanning regions; and
said driving means includes:
a first driving circuit which sequentially supplies a drive signal based on a video signal to each of the row wirings intersecting the n/2 column wirings to which said first scanning circuit is assigned, synchronously with selection made by said first scanning circuit; and
a second driving circuit which sequentially supplies a drive signal based on a video signal to each of the row wirings intersecting the n/2 column wirings to which said second scanning circuit is assigned, synchronously with selection made by said second scanning circuit.

13. An image display device according to claim 11, wherein said first and second scanning circuits are configured to sequentially select the column wirings.

14. An image display device according to claim 9, wherein said display pixel includes an electron emission element.

15. An image display device according to claim 9, wherein the video signal is supplied from a video processing circuit to said driving section, and said video processing circuit includes scanning direction changing means for storing input pixel data into a frame memory in units of rows and retrieving the pixel data from said frame memory in units of columns.

16. An image display device according to claim 12, wherein the video signal is supplied from a video processing circuit to said first and second driving circuit, and said video processing circuit includes scanning direction changing means for storing input pixel data into a frame memory in units of rows and retrieving the pixel data for one scanning region from said frame memory in units of columns as the video signal to be supplied to said first driving circuit and the pixel data for the other scanning region in units of columns as the video signal to be supplied to said second driving circuit.

17. An image displaying method for a display section in which (m×n) display pixels are arrayed in a matrix form and located at intersections of m row wirings and n column wirings, a length L of the row being greater or equal to a length K of the column, comprising:
sequentially selecting said column wirings; and
supplying a drive signal to each of said row wirings based on a video signal synchronously with selection of the column wiring.

18. An image displaying method according to claim 17, wherein said column wirings are connected to said display pixels for color display.
